(19) United States
(12) Patent Application Publication
(10) Pub. No.: US 2011/0103882 A1
(43) Pub. Date: May 5, 2011

(54) PIPE FLANGE GUIDE SHROUD

(76) Inventor: Bradford A. McDavid, Urbana, OH (US)

(21) Appl. No.: 12/611,157

(22) Filed: Nov. 3, 2009

(51) Int. Cl. F16B 7/00; F16L 35/00

(52) U.S. Cl. 403/14; 285/24

(57) ABSTRACT

A pipe flange shroud may have a body with an opening; a first rim having a rib; and, a second rim having a rib. The first rim may guide a first pipe connector into the pipe flange shroud and the second rim may guide a second pipe connector into the pipe flange shroud. The pipe flange shroud may thus align the first pipe connector to the second pipe connector.

### I. BACKGROUND

A. Field of Invention

This invention relates to the art of automotive pipes and more specifically to methods and apparatuses related to connecting automotive pipes together.

B. Description of the Related Art

It is well known in the automotive industry to provide vehicles with pipes of various types and sizes to convey fluids. Automotive pipes are used, for example, to convey air, water, hydraulic fluid and oil. Pipes are also used in heating, ventilating, and air conditioning systems (commonly referred to collectively as HVAC systems) to convey a refrigerant.

A common difficulty with automotive pipes is connecting them together and connecting them to automotive components. The relatively restricted space available for automotive pipes makes such connections difficult and labor intensive. While known methods and devices for connecting automotive pipes generally work well for their intended purposes, there is a need for improvements.

### II. SUMMARY

According to one embodiment of this invention, a pipe flange shroud may comprise: a body having an opening therethrough; a first side having a first rim defining a first end of the opening; a second side having a second rim defining a second end of the opening; at least a first rib positioned on an inner surface of the first rim to guide a first associated pipe connector into the first rim; and, at least a second rib positioned on an inner surface of the second rim to guide a second associated pipe connector into the second rim. The pipe flange shroud may align the first associated pipe connector to the second associated pipe connector as the first and second associated pipe connectors are received within the first and second rims, respectively.

According to another embodiment of this invention, a pipe connection assembly may comprise: a first pipe connector having at least a first hole that receives a first associated pipe; a second pipe connector having at least a first hole that receives a second associated pipe; a pipe flange shroud comprising: (1) a body having an opening therethrough; (2) a first side having a first rim defining a first end of the opening; (3) a second side having a second rim defining a second end of the opening; (4) at least a first rib positioned on an inner surface of the first rim to guide the first pipe connector into the first rim; and, (5) at least a second rib positioned on an inner surface of the second rim to guide the second pipe connector into the second rim. The pipe flange shroud may align the first associated pipe to the second associated pipe as the first and second pipe connectors are received within the first and second rims, respectively.

According to yet another embodiment of this invention, a method may comprise the steps of: (A) providing a pipe flange shroud comprising: (1) a body having an opening therethrough; (2) a first side having a first rim defining a first end of the opening; (3) a second side having a second rim defining a second end of the opening; (4) at least a first rib positioned on an inner surface of the first rim; (5) at least a second rib positioned on an inner surface of the second rim; (B) using the first rib to guide a first pipe connector into the first rim; and, (C) using the second rib to guide a second pipe connector into the second rim.

One advantage of this invention is that automotive piping can be easily connected together, reducing manpower and manufacturing assembly costs.

Another advantage of this invention is that automotive piping can be easily aligned to maintain a high level of performance.

Another advantage of this invention is that an automotive piping connection assembly can be easily made and assembled.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a front perspective view of a sedan.

FIG. 2 is a bottom perspective view of a portion of an automotive air conditioning system.

FIG. 3 is an enlarged view of area A from FIG. 2.

FIG. 4 is a side perspective view of the automotive air conditioning system shown in FIG. 2.

FIG. 5 is an enlarged view of area B from FIG. 4.

FIG. 6 is a schematic representation of an air conditioning system.

FIG. 7 is a perspective side view of a pipe connection assembly having a pipe flange shroud and a pipe connector.

FIG. 8 is a perspective opposite side view of the pipe connection assembly shown in FIG. 7.

FIG. 9 is a perspective view of the pipe connection assembly similar to that shown in FIG. 8 but with another pipe connector added.

FIG. 10 is a side perspective view of the pipe connection assembly being put together.

FIG. 11 is a top perspective view similar to that shown in FIG. 10 but with the lip visible.

FIG. 12 is a side view of a pipe connection assembly illustrating the ribs that may be positioned on an inner surface of the rim of the pipe flange shroud.

FIG. 13 is a sectional view of the pipe connection assembly of FIG. 11 after the pipe connection assembly is put together.

### IV. DETAILED DESCRIPTION

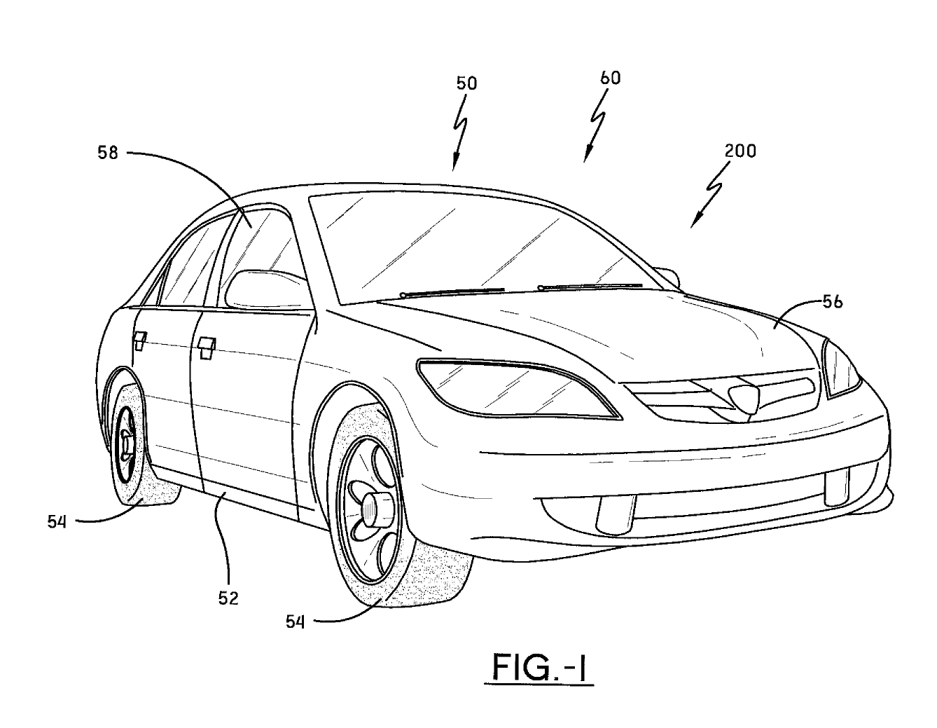

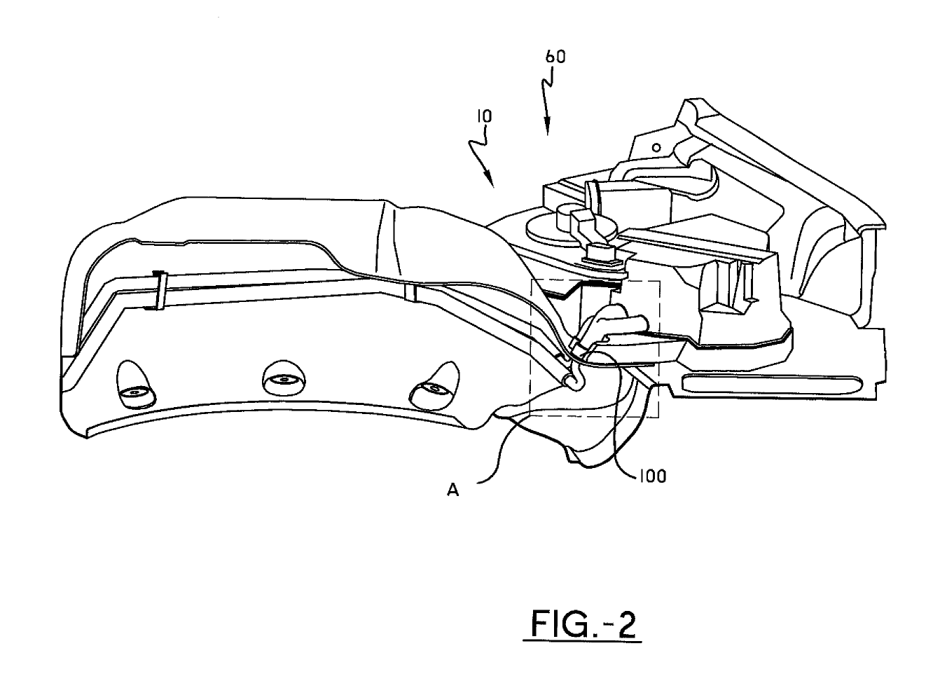

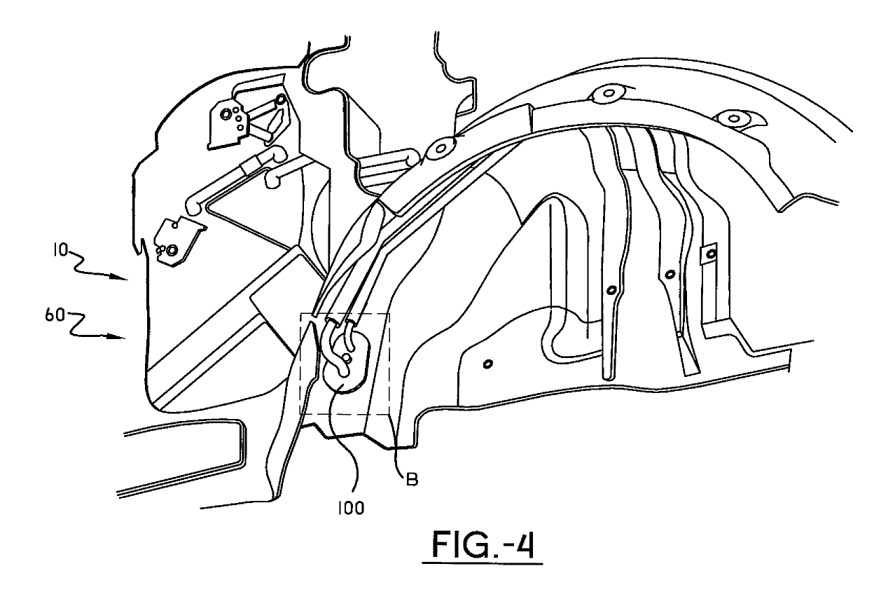

Referring now to the drawings wherein the showings are for purposes of illustrating embodiments of the invention only and not for purposes of limiting the same, and wherein like reference numerals are understood to refer to like components, FIG. 1 shows a vehicle 50 that may be equipped with one or more pipe flange shrouds 200 according to this invention. While the vehicle 50 shown is a sedan, it is to be understood that the pipe flange shroud 200 of this invention will work with any vehicle including, for some non-limiting examples, cars, sports utility vehicles (SUVs), trucks, motorcycles, aircraft and sea-faring vessels. The vehicle 50 may include a frame 52, one or more ground engaging wheels 54 mounted to the frame 52, and a locomotion source 56, such as an engine or motor, mounted to the frame 52, for use in providing locomotion for the vehicle 50. The vehicle 50 may also have a passenger compartment 58 supported to the frame 52 which houses one or more passengers as is well known in the art. An HVAC system 60 may be supported to the frame 52 and used to adjust the temperature in the passenger compartment 58. The HVAC system 60 may include a heating system (not shown) that heats air to be distributed to the passenger compartment 58 and an air conditioning system 10 (see FIGS. 2, 4 and 6) that cools air to be distributed to the passenger compartment 58. A control mechanism (not shown) may be used to determine the quantity and temperature of air that is circulated into the passenger compartment 58.

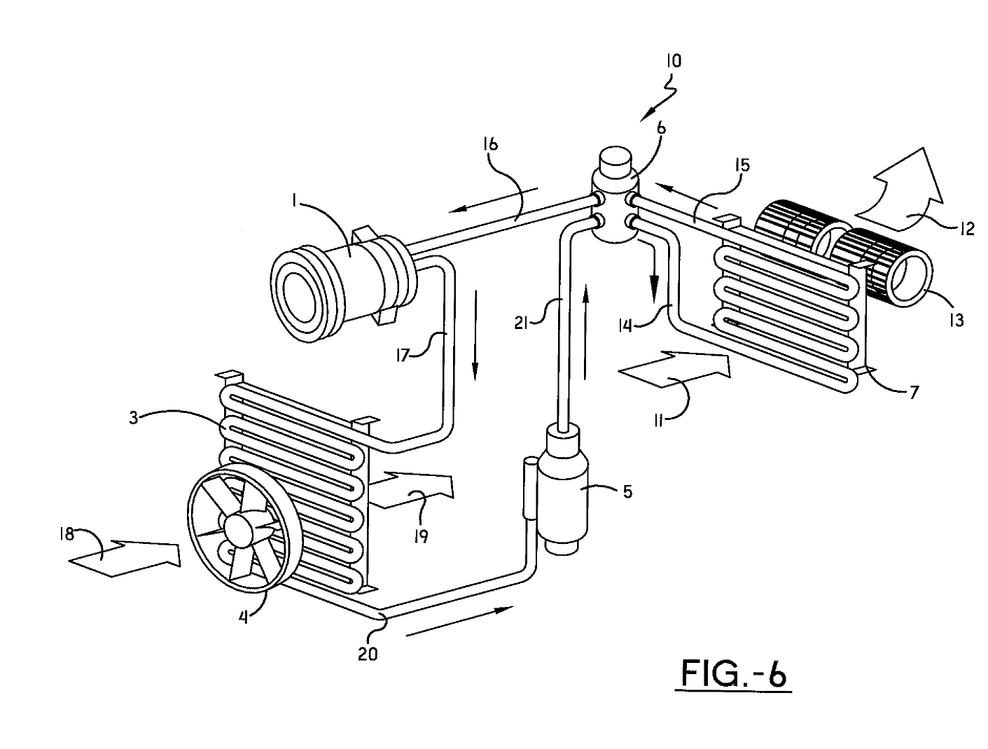

FIG. 6 shows the air conditioning system 10 schematically. Arrow 11 represents air to be cooled and arrow 12 represents the air after it has been cooled and is being circulated, by blower mechanism 13, into the passenger compartment 58. The air 11 is cooled by passing it through a heat exchanger, or evaporator, 7. Evaporator 7 is filled via piping 14 with a refrigerant. The refrigerant exits the evaporator 7 via piping 15 and passes through expansion valve 6. The refrigerant is then carried by piping 16 to compressor 1. Piping 17 transfers the refrigerant from the compressor 1 to another heat exchanger, or condenser 3. The condenser 3 is used to transfer heat away from the refrigerant. Typically this heat transfer is accomplished by blowing atmospheric air 18 with a condenser fan 4 through the condenser 3. The now relatively heated air 19 is typically returned to the atmosphere. The refrigerant exits the condenser 3 via piping 20 and passes through receiver/dryer 5 and then through piping 21 to expansion valve 6. To complete the cycle, the refrigerant then passes through the previously noted piping 14 into the evaporator 7. As the operation of an air conditioning system as well as the other components of an HVAC system are well known to those of skill in the art, further details will not be provided.

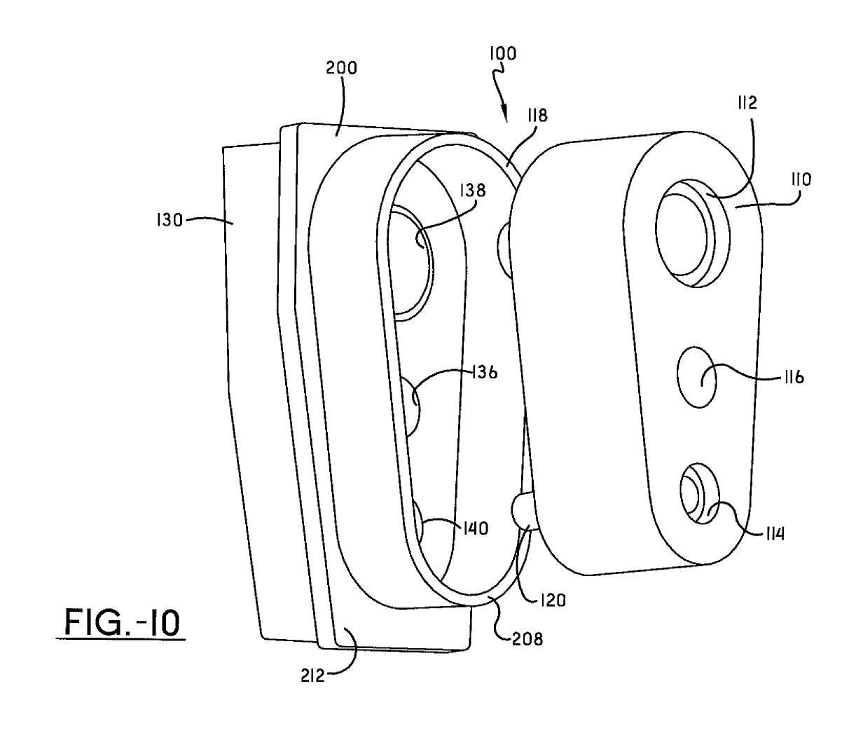

With reference now to FIGS. 2-6, 10-11 and 13, while the pipe flange shroud 200 will be described in use with air conditioning system refrigerant pipes (such as any of the pipes 14, 15, 16, 17, 20 and 21 shown in FIG. 6), it should be understood that the pipe flange shroud 200 of this invention will work with any pipe (or piping) chosen with the sound judgment of a person of skill in the art. It should also be noted that while the pipe flange shroud 200 embodiments shown are for pipe to pipe connections, the pipe flange shroud 200 can also be used to connect a pipe to a component (such as any of the pipes 14, 15, 16, 17, 20 and 21 shown in FIG. 6 being connected to any of the corresponding components 1, 3, 5, 6 and 7). The word “pipe” (or piping) as used in this patent means any conduit used to transfer a fluid. Thus, “pipe” includes all types of pipes, tubes, hoses, ducts and the like. The air conditioning system 10 may include a pipe connection assembly 100 that is used to connect one or more pipes. For the embodiment shown in FIGS. 2-5, the pipe connection assembly 100 is used to connect refrigerant pipe 64 to refrigerant pipe 66 and to connect refrigerant pipe 68 to refrigerant pipe 70. It should be understood, however, that the pipe connection assembly 100 can be used to connect any number of pipes chosen with the sound judgment of a person of skill in the art. As seen best in FIGS. 10-11 and 13, the pipe connection assembly 100 may include the pipe flange shroud 200, a first pipe connector 110 and a second pipe connector 130.

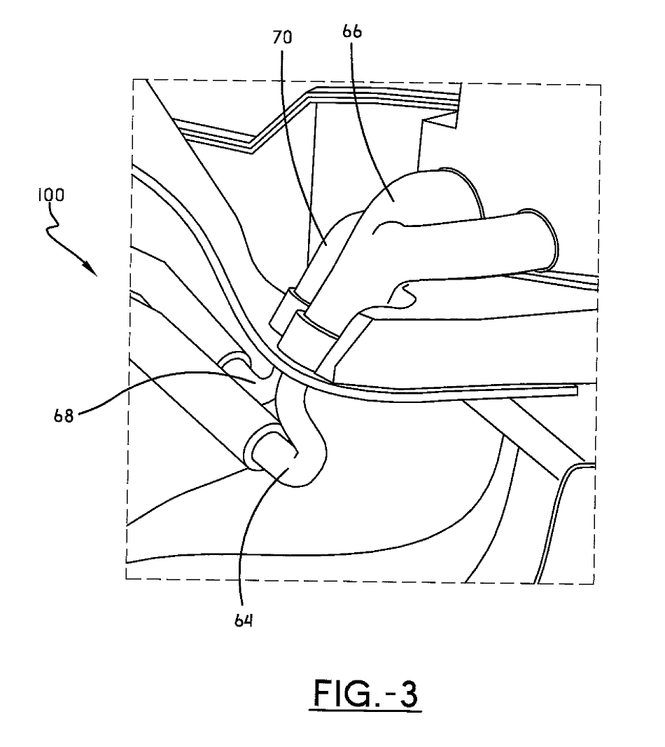

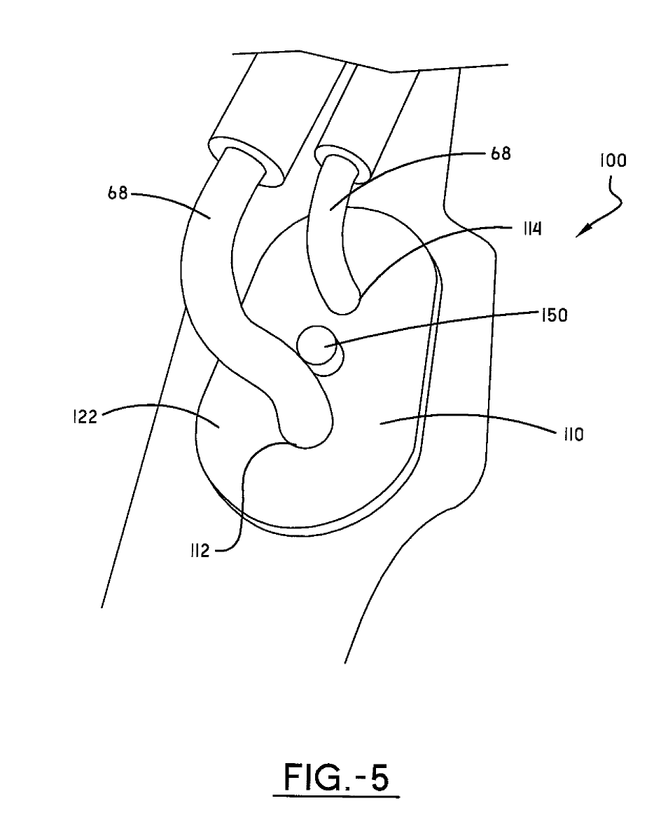

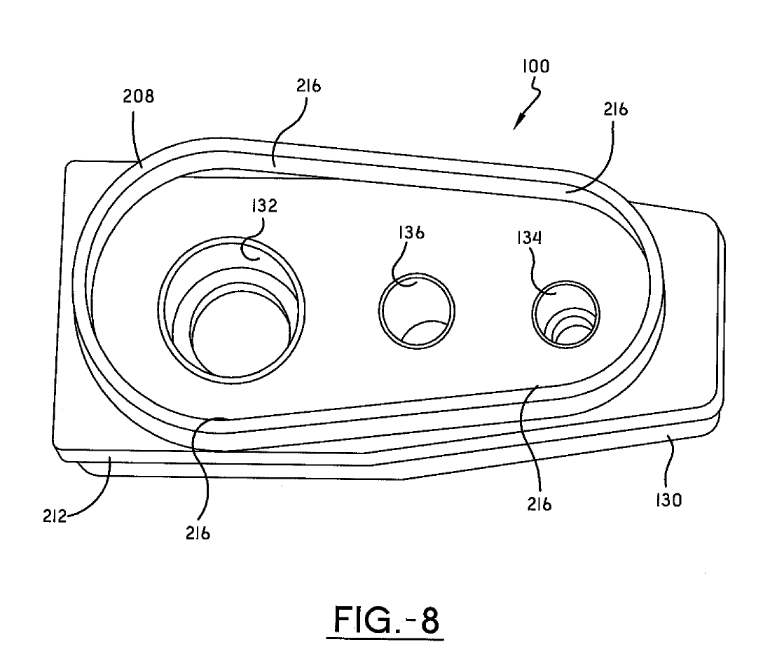

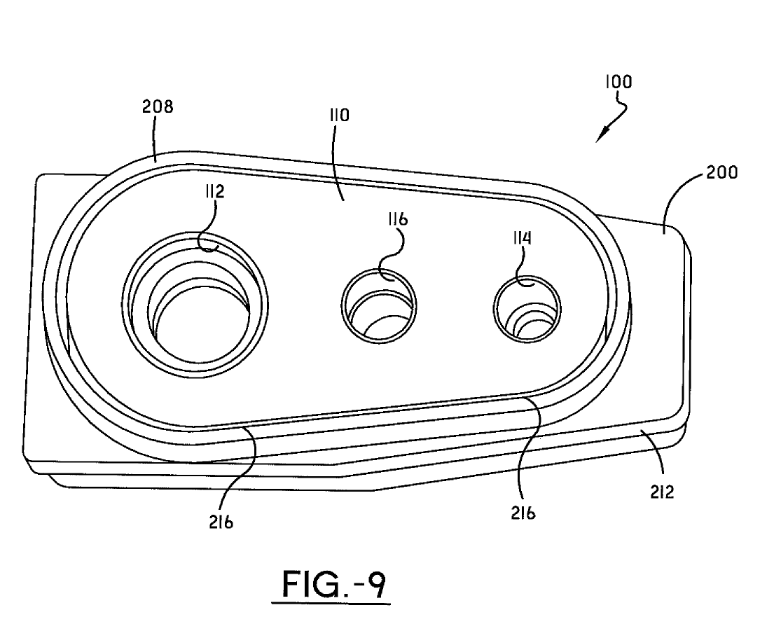

With reference now to FIGS. 3, 5 and 7-13, the pipe connector 110 may have one hole for receiving each pipe to be connected to it. Pipe connector 110 has first and second holes 112, 114 for this purpose. Pipe connector 130 similarly may have one hole for receiving each pipe to be connected to it. Pipe connector 130 has first and second holes 132, 134 for this purpose. The manner in which the pipes are received within the holes is known to those of skill in the art and thus will not be described here. The pipe connectors 110, 130 may have additional holes, such as holes 116, 136, used for other purposes as well. A fastener or dowel pin 150 for example, seen best in FIG. 5, may be received within the holes 116, 136 to assist in aligning the first pipe connector 110 to the second pipe connector 130. The fastener 150 may be connected in any manner chosen with the sound judgment of a person of skill in the art. In one embodiment, the fastener 150 may include a threaded portion and thus serve as a bolt or stud. The threaded fastener 150 may then be received within a nut (not shown) or received within threaded portion of either of the pipe connectors 110, 130. All the holes can be sized and shaped in any manner chosen with the sound judgment of a person of skill in the art in accordance with the purpose for the hole. It is also contemplated to use a hole for more than one purpose. The holes 116, 136 may be used, as in the embodiment shown, to receive a fastener 50 as described above. In another embodiment, not shown, the holes 116, 136 may be used to connect another set of pipes together similar to that done with holes 112, 132 and 114, 134. Once the pipe connector 110 is connected to the pipe connector 130, the holes 112 and 132 are substantially collinear and thus the respective pipes that they receive, pipes 64 and 66, are properly aligned to convey the refrigerant therethrough. Similarly, once the pipe connector 110 is connected to the pipe connector 130, the holes 114 and 134 are substantially collinear and thus the respective pipes that they receive, pipes 68 and 70, are properly aligned to convey the refrigerant therethrough.

With reference now to FIGS. 10-11 and 13, to improve the connection and alignment of the first pipe connector 110 to the second pipe connector 130, either connector may have a pilot or convex member that is received within an aperture or concave member formed on the other connector. In one embodiment (not shown) pipe connector 130 may have at least one pilot that is received in a corresponding aperture formed in pipe connector 110. For the embodiment shown, pipe connector 110 has two pilots 118, 120 that are received in apertures 138, 140, respectively, formed in pipe connector 130. Each pilot and corresponding aperture may be positioned and sized in any manner chosen with the sound judgment of a person of skill in the art. For the embodiment shown, each pilot is substantially concentric with a hole in the first pipe connector 110 and each aperture is substantially concentric with a hole in the second pipe connector 130. In a specific embodiment, pilot 118 is concentric with hole 112 and pilot 120 is concentric with hole 114. Also, aperture 138 is concentric with hole 132 and aperture 140 is concentric with hole 134. As a result, for this embodiment pilot 118, hole 112, aperture 138 and hole 132 are all concentric with each other once the first pipe connector 110 is connected to the second pipe connector 130. Similarly, for this embodiment pilot 120, hole 114, aperture 140 and hole 134 are all concentric with each other once the first pipe connector 110 is connected to the second pipe connector 130.

With reference now to FIGS. 3, 5, 11 and 13, the pipe connectors 110, 130 may be formed in any manner and of any material chosen with the sound judgment of a person of skill in the art. The pipe connectors 110, 130 may be formed of aluminum, for example. Either or both of the pipe connectors 110, 130 may have additional features as required. For the embodiment shown, the pipe connector 110 has a lip 122 (see FIGS. 5, 11 and 13) that extends from the body of the connector 110 and is used to seal the connector 110 to a surrounding surface (see especially FIG. 5). In another embodiment, the lip 122 may be used to support the pipe connection assembly 100 to the vehicle 10. See, for example, FIG. 3. In yet another embodiment, at least one of the connectors 110, 130 may be supported solely from the pipes that connect to them (as does connector 130 in the embodiment shown).

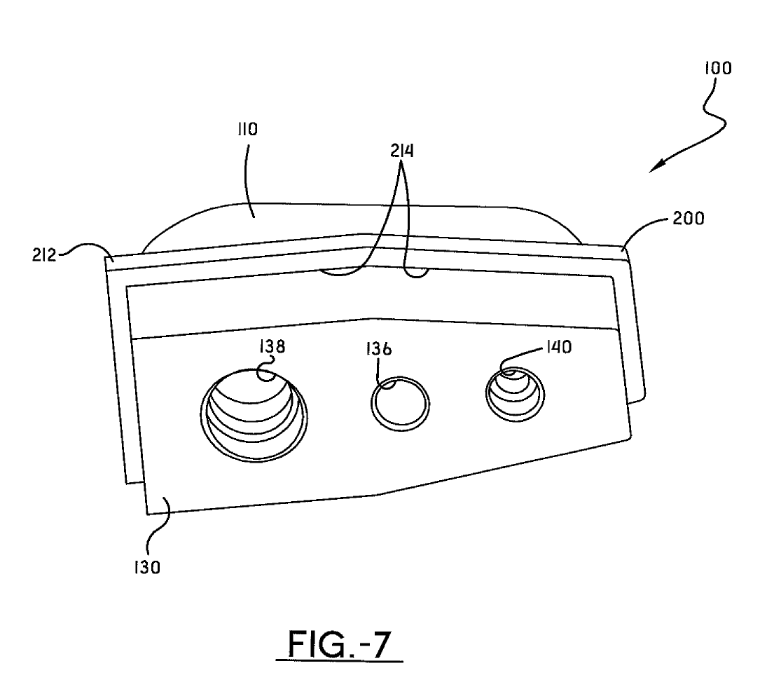

With reference now to FIGS. 7-13, the pipe flange shroud 200 will now be described. The pipe flange shroud 200 may include a body 202 having an opening 204 therethrough. A first side 206 of the pipe flange shroud 200 may have a first rim 208 defining a first end of the opening 204. A second side 210 of the pipe flange shroud 200 may have a second rim 212 defining a second end of the opening 204. The first rim 208 may be used to receive the first pipe connector 110 while the second rim 212 may be used to receive the second pipe connector 130. The pipe flange shroud 200 may thus be used to easily align the first pipe connector 110 to the second pipe connector 130 and thereby align the corresponding pipes. The rims 208, 212 may be sized and shaped to receive the corresponding connectors 110, 130. As a result, the rims 208, 212 may have different shapes and different circumferences, as shown.

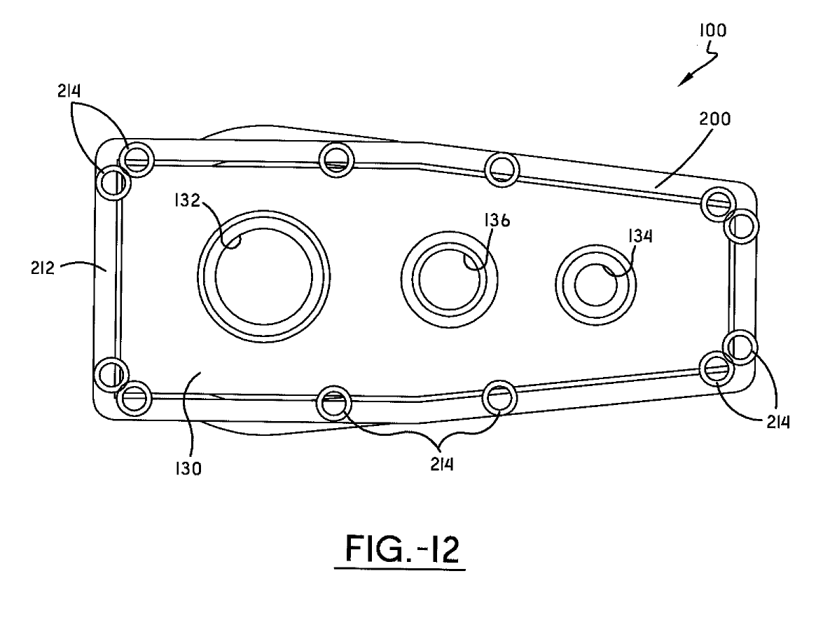

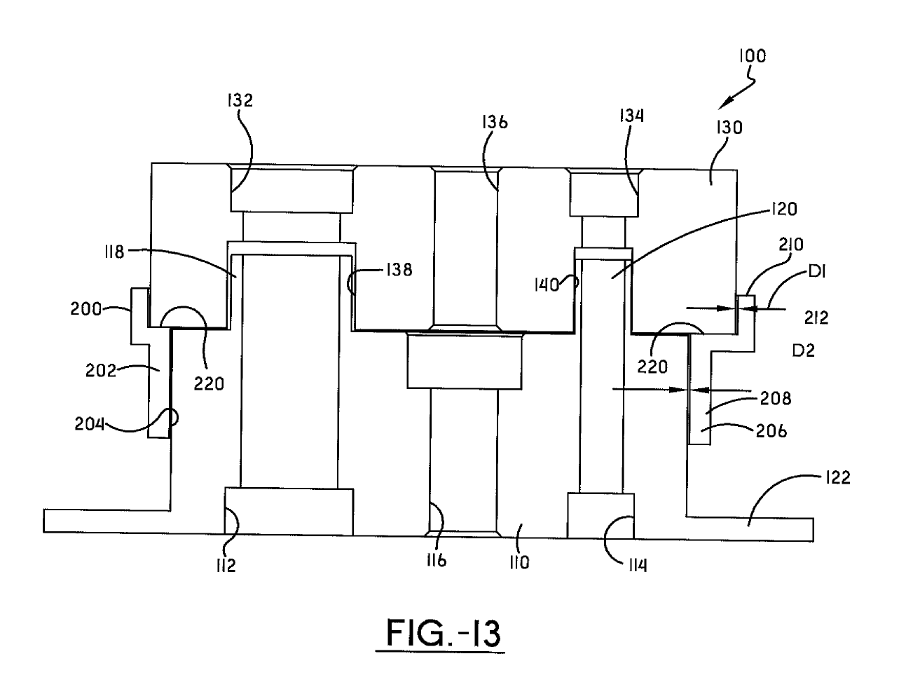

With continuing reference to FIGS. 7-13, to guide the pipe connector 130 within the rim 212, at least one rib 214 may be positioned on an inner surface of the rim 212. In one embodiment, shown, a plurality of ribs 214 are positioned on the inner surface of the rim 212. For the specific embodiment shown, see especially FIG. 12, 12 ribs 214 are positioned around the perimeter of inner surface of the rim 212. As noted, these ribs 214 guide the pipe connector 130 into proper positioned within the pipe flange shroud 200. In one embodiment, the ribs 214 create a press fit between the pipe connector 130 and the rim 212. In this case, the ribs 214 are compressed or crushed as the pipe connector 130 is inserted within the rim 212. The ribs 214 can be of any size and shape chosen with the sound judgment of a person of skill in the art. In one embodiment, the ribs 214 extend from the inner surface of the rim 212 a distance D1 (see FIG. 13) that may be approximately 0.5 millimeters. To guide the pipe connector 110 within the rim 208, at least one rib 216 may be positioned on an inner surface of the rim 208. In one embodiment, shown, a plurality of ribs 216 are positioned on the inner surface of the rim 208. For the specific embodiment shown, see especially FIG. 12, six ribs 216 are positioned around the perimeter of inner surface of the rim 208. In one embodiment, the ribs 216 create a press fit between the pipe connector 110 and the rim 208. In another embodiment, the ribs 216 guide the pipe connector 110 within the rim 208 but they do not create a press fit. The ribs 216 can be of any size and shape chosen with the sound judgment of a person of skill in the art. In one embodiment, the ribs 216 extend from the inner surface of the rim 208 a distance D2 (see FIG. 13) that may be approximately 0.5 millimeters.

With reference now to FIG. 13, the pipe flange shroud 200 may also have a contact surface 220 that limits the travel of one of the pipe connectors 110, 130 with respect to the pipe flange shroud 200. In one embodiment, the contact surface 220 is positioned to limit the travel of the pipe connector 130 so that the pipe connector 130 is properly positioned to be connected to the pipe connector 110. The contact surface 220 may be positioned in any manner chosen with the sound judgment of a person of skill in the art. For the embodiment shown, the contact surface 220 extends outwardly beyond at least a portion of the outer surface of the pipe connector 110. The pipe flange shroud 200 may be foamed in any manner and of any material chosen with the sound judgment of a person of skill in the art. In one embodiment, the pipe flange shroud 200 is formed of an elastomeric material such as plastic or resin and is shaped in a molding process.

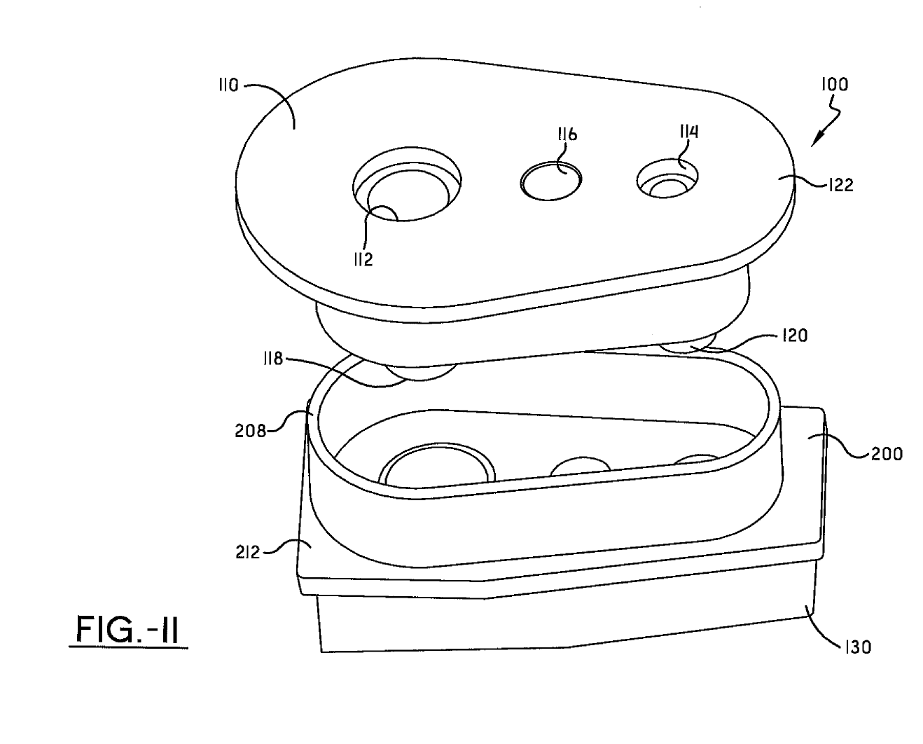

With reference now to all the FIGURES, a method of building the pipe connection assembly 100 will now be described. First, the pipe connector 130 is inserted into the rim 212. If the rim 212 has one or more ribs 214, the ribs 214 serve to guide the pipe connector 130 into place. If the ribs 214 create a press fit, the pipe connector 130 achieves a press fit within the rim 212. If the pipe flange shroud 200 has a contact surface 220, the pipe connector 130 is inserted into the rim 212 until the pipe connector 130 contacts the contact surface 220. The contact surface 220 limits or stops any additional relative motion of the pipe connector 130 into the rim 212. Once the pipe connector 130 is thus positioned within the pipe flange shroud 200, as shown in FIG. 10, the pipe connector 110 is then inserted into the rim 208. This motion is shown with arrows in FIG. 11. If the rim 208 has one or more ribs 216, the ribs 216 serve to guide the pipe connector 110 into place. In one embodiment, the pipe connector 110 is aligned with respect to the pipe connector 130 before the pipe connector 110 contacts the pipe connector 130. Continued movement of the pipe connector 110 toward the pipe connector 130 permits the pilots 118, 120, if used, to be received within the corresponding apertures 138, 140. The pipe connector 110 is moved until it contacts the pipe connector 130 whereby all holes, the pipe connectors 110, 130, and the corresponding pipes are all properly aligned, as shown in FIG. 13. If desired and used, the fastener 50 may be inserted into the holes 116, 136 as a final connection device. It should be noted that other devices and methods may also be incorporated, if desired, to improve the seal between the pipe flange shroud 200, connectors 110, 130 and pipes. An O-ring or gasket, for example, could be used between these components in any manner known to those of skill in the art.

Numerous embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/We claim:

1. A pipe flange shroud comprising:
a body having an opening therethrough;
a first side having a first rim defining a first end of the opening;
a second side having a second rim defining a second end of the opening;
at least a first rib positioned on an inner surface of the first rim to guide a first associated pipe connector into the first rim;
at least a second rib positioned on an inner surface of the second rim to guide a second associated pipe connector into the second rim; and,
wherein the pipe flange shroud aligns the first associated pipe connector to the second associated pipe connector as the first and second associated pipe connectors are received within the first and second rims, respectively.

2. The pipe flange shroud of claim 1 wherein a plurality of ribs are positioned on the inner surface of the first rim and they create a press fit between the first associated pipe connector and the first rim.

3. The pipe flange shroud of claim 1 further comprising:
a contact surface that limits the travel of the first associated pipe connector within the first rim.

4. The pipe flange shroud of claim 1 wherein the circumference of the first rim is substantially different than the circumference of the second rim.

5. The pipe flange shroud of claim 4 wherein the first rim is shaped substantially different than the second rim.

6. The pipe flange shroud of claim 1 wherein the pipe flange shroud is formed substantially of a plastic material and is formed in a molding process.

7. The pipe flange shroud of claim 1 wherein:
a plurality of ribs are positioned on the inner surface of the first rim to guide the first associated pipe connector into the first rim;
a plurality of ribs are positioned on the inner surface of the second rim to guide the second associated pipe connector into the second rim;
a contact surface is positioned on the pipe flange shroud and limits the travel of the first associated pipe connector within the first rim; and,
the pipe flange shroud is mounted to a vehicle and used with an air conditioning system.

8. A pipe connection assembly comprising:
a first pipe connector having at least a first hole that receives a first associated pipe;
a second pipe connector having at least a first hole that receives a second associated pipe;
a pipe flange shroud comprising:
(1) a body having an opening therethrough;
(2) a first side having a first rim defining a first end of the opening;
(3) a second side having a second rim defining a second end of the opening;
(4) at least a first rib positioned on an inner surface of the first rim to guide the first pipe connector into the first rim;
(5) at least a second rib positioned on an inner surface of the second rim to guide the second pipe connector into the second rim, and,
wherein the pipe flange shroud aligns the first associated pipe to the second associated pipe as the first and second pipe connectors are received within the first and second rims, respectively.

9. The pipe connection assembly of claim 8 wherein:
the first pipe connector has a first pilot;
the second pipe connector has a first aperture; and,
the first pilot is received within the first aperture as the first and second pipe connectors are moved toward each other.

10. The pipe connection assembly of claim 9 wherein:
the first pilot is substantially concentric with the first hole of the first pipe connector;
the first aperture is substantially concentric with the first hole of the second pipe connector;
the first pipe connector has a second hole that receives a third associated pipe and a second pilot that is substantially concentric with the second hole of the first pipe connector;
the second pipe connector has a second hole that receives a fourth associated pipe and a second aperture and that is substantially concentric with the second hole of the first pipe connector;
the second pilot is received within the second aperture as the first and second pipe connectors are moved toward each other; and,
the pipe flange shroud aligns the third associated pipe to the fourth associated pipe as the first and second pipe connectors are received within the first and second rims.

11. The pipe connection assembly of claim 9 wherein a plurality of ribs are positioned on the inner surface of the first rim and they create a press fit between the first pipe connector and the first rim.

12. The pipe connection assembly of claim 11 further comprising:
a contact surface that limits the travel of the first pipe connector within the first rim.

13. The pipe connection assembly of claim 12 wherein the circumference of the first rim is substantially different than the circumference of the second rim.

14. The pipe connection assembly of claim 13 wherein:
a plurality of ribs are positioned on the inner surface of the second rim to guide the second pipe connector into the second rim;
the pipe flange shroud is formed substantially of a plastic material and is formed in a molding process;
the first and second pipe connectors are formed substantially of aluminum;
the first and second associated pipes convey a refrigerant; and,
the pipe connection assembly is mounted to a vehicle and used with an air conditioning system.

15. A method comprising the steps of:
(A) providing a pipe flange shroud comprising:
(1) a body having an opening therethrough;
(2) a first side having a first rim defining a first end of the opening;
(3) a second side having a second rim defining a second end of the opening;
(4) at least a first rib positioned on an inner surface of the first rim;
(5) at least a second rib positioned on an inner surface of the second rim;
(B) using the first rib to guide a first pipe connector into the first rim; and,
(C) using the second rib to guide a second pipe connector into the second rim.

16. The method of claim 15 wherein:
step (B) comprises the step of: creating a press fit between the first pipe connector and the first rim by crushing the first rib as the first pipe connector is inserted into the first rim.

17. The method of claim 15 wherein:
the method further comprises the steps of: providing the first pipe connector with a first hole that receives a first pipe; and, providing the second pipe connector with a second hole that receives a second pipe; and,
step (C) comprises the steps of aligning the first hole with the second hole; and, aligning the first pipe with the second pipe.

18. The method of claim 15 wherein:
the method further comprises the steps of: providing the first pipe connector with a first pilot; and, providing the second pipe connector with a first aperture; and,
step (C) comprises the step of: inserting the first pilot within the first aperture.

19. The method of claim 15 wherein:
the method further comprises the steps of: providing the first pipe connector with a first hole that receives a first pipe; and, providing the second pipe connector with a second hole that receives a second pipe; and,
step (C) comprises the steps of: aligning the first hole with the second hole; and, aligning the first pipe with the second pipe.

20. The method of claim 15 wherein:
step (A) comprises the step of: providing the pipe flange shroud with a contact surface; and,
step (B) comprises the step of: inserting the first pipe connector into the first rim until the first pipe connector contacts the contact surface.
